(19) United States
(12) Patent Application Publication
(10) Pub. No.: US 2007/0130523 A1
(43) Pub. Date: Jun. 7, 2007

(54) User interface automatic transform system and method based on display device

(76) Inventors: Tai-Yeon Ku, Daejon (KR); Dong-Hwan Park, Daejon (KR); Kyeong-Deok Moon, Daejon (KR); Jun-Hee Park, Daejon (KR)

Correspondence Address: LADAS & PARRY LLP, 224 SOUTH MICHIGAN AVENUE, SUITE 1600, CHICAGO, IL, 60604, US

(21) Appl. No.: 11/605,743

(22) Filed: Nov. 29, 2006

(30) Foreign Application Priority Data
Dec. 1, 2005 (KR) 10-2005-0116170
Aug. 2, 2006 (KR) 10-2006-0072996

(51) Int. Cl. G06F 17/00

(52) U.S. Cl. 715/746

(57) ABSTRACT

Provided is a user interface automatic transform system and method based on a display device. The system includes: a graphic user interface (GUI) managing unit for storing and managing style information of the display device and managing mapping information of a GUI library; a transform rule managing unit for storing and managing a transform rule; a user interface database managing unit for storing and managing an original user interface; a renderer agent managing unit for creating an agent for communication with the display device; an authoring agent managing unit for creating an agent for communication with the authoring tool; and a transform unit for creating an adaptive user interface.

### FIELD OF THE INVENTION

The present invention relates to a user interface automatic transform system and method based on a display device; and, more particularly, to a user interface automatic transform system which transforms and provides a user interface targeted by an application developer in real-time according to characteristics of a user device, and a method thereof.

### DESCRIPTION OF RELATED ART

Increasing number of devices provides the Internet service, such as a personal computer (PC), personal digital assistants (PDA) and mobile phones and even clocks. Each device has its own attributes such as input/output devices, different display sizes, and an operating system (OS). Also, each device has its own user interface.

Some of the devices adopts a key board, a mouse, others adopt a touch screen as an input device. There are also devices which do not have a screen and input data by a voice.

When an application driven by each device is designed, diverse characteristics of the device should be reflected. The characteristics to be considered include a resolution of a screen and a limitation of an input/output device in the respect of performance of the device. It is also considered whether to use Windows or Linux as an operating system, and what is used as a graphic library. The application should be individually produced according to the consideration and loaded in each device.

It wastes time and human resources. This operation may require reorganization and redesign in addition to simple potting. Therefore, the conventional application producing method is not proper to the ubiquitous environment and has a problem that it calls for another work.

### SUMMARY OF THE INVENTION

It is, therefore, an object of the present invention to provide a user interface automatic transform system and method based on a display device, which forms one user interface targeted by an application developer, stores the user interface in a database, transforms the original user interface stored in the database in conformity to characteristics of a display device by and provides the user interface in real-time, and a method thereof.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a system for automatically transforming a user interface by communicating with a renderer mounted on a display device and communicating with an authoring tool of the user interface, including: a graphic user interface (GUI) managing unit for storing and managing style information of the display device corresponding to information of the display device and managing mapping information of a GUI library in a mapping table; a transform rule managing unit for storing and managing a transform rule according to characteristics of the display device; a user interface database managing unit for storing and managing an original user interface authored by the authoring tool; a renderer agent managing unit for creating an agent for communication with the display device; an authoring agent managing unit for creating an agent for communication with the authoring tool; and a transform unit for creating an adaptive user interface by acquiring the style information of the display device and mapping information of the GUI library from the GUI managing unit based on the display device information transmitted from the renderer, acquiring the transform rule from the transform rule managing unit based on the information of the display device, and transforming the original user interface read from the user interface database managing unit based on the style information, the mapping information of the GUI library and the transform rule of the display device.

In accordance with another aspect of the present invention, there is provided a method for automatically transforming an original user interface according to a display device, including the steps of: a) registering the original user interface formed by an authoring tool in a database and storing style information of the display device and mapping information of a GUI library; b) registering a transform rule for transforming a user interface correspondingly to the style information of each display device; c) receiving a user interface request from a renderer of the display device, acquiring the style information of the display device and the mapping information of the GUI library based on the information of the display device, and acquiring a transform rule; d) transforming the stored original user interface based on the acquired style information of the display device, the mapping information of the GUI library and the transform rule and creating an adaptive user interface; and e) providing the created adaptive user interface to the renderer of the display device.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a user interface automatic transform system in accordance with an embodiment of the present invention; and

FIG. 2 is a flowchart describing an automatic transforming method of the user interface in accordance with an embodiment of the present invention.

### DETAILED DESCRIPTION OF THE INVENTION

Other objects and advantages of the present invention will become apparent from the following description of the embodiments with reference to the accompanying drawings. Therefore, those skilled in the art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

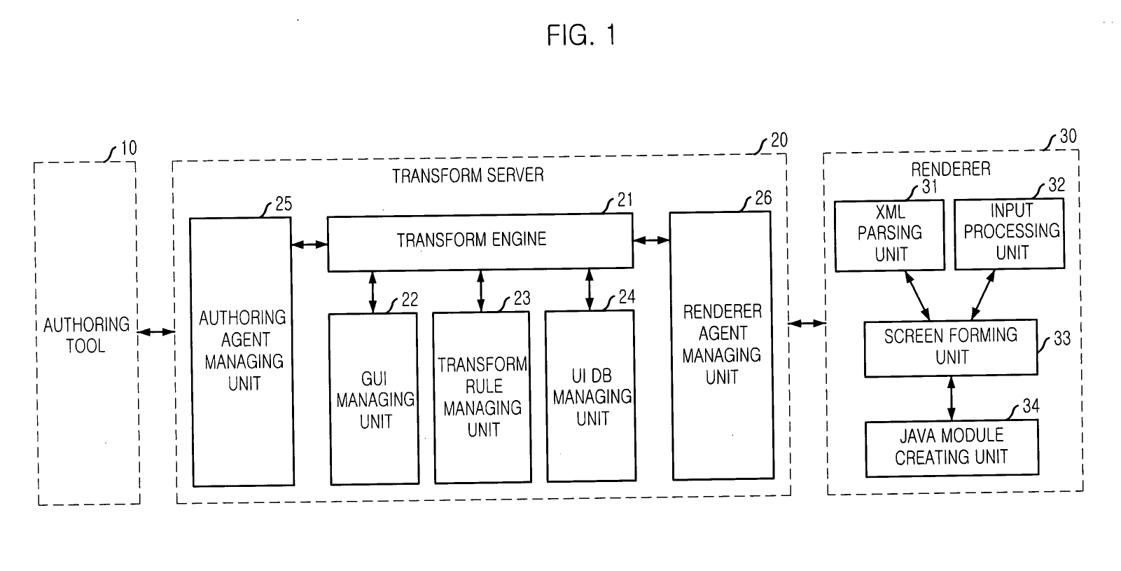

FIG. 1 is a block diagram showing a user interface automatic transform system in accordance with an embodiment of the present invention.

A user interface automatic transform module is a module embedded into a home server for managing a user interface of a plurality of devices on a home network. The home server manages the user interfaces for controlling the devices on the home network. Also, the home server collects and manages detailed information on a display device which can display information of the user interface. All information is displayed in an Extensible Markup Language (XML), and the automatic transform module of the home server transforms the SML script in conformity to the characteristics of the display device so that a renderer of the display device can be displayed.

An authoring tool 10 is a tool required when a developer distributes a device. The authoring tool 10 interacts with an authoring agent managing unit 25 of a transform server. A developer forms only a user interface for a device targeted by the developer and the formed original user interface is stored in a database (DB) of the transform server 20.

The authoring tool 10 checks an adaptive user interface that is obtained by transforming an original user interface stored in the transform server 20 according to the display device through a preview means in advance. Accordingly, the developer may correct a transform rule stored in the transform server 20.

Also, a user graphic user interface (GUI) renderer 30 is a browser for displaying an actual user interface. When a user executes the renderer, the renderer provides a style sheet of its own display device to the transform server 20. The transform server 20 transforms the user interface based on the style sheet of the display device provided from the renderer 30 and retransmits the user interface to the renderer 30.

The renderer 30 parses the transformed XML script transmitted from the transform server 30 and displays the XML script on actual screen.

The transform server 20 stores the original user interface developed by the developer in the DB, stores a transform rule formed by the developer and applies a transform rule in conformity to the characteristics of the display device upon request of the renderer 30, thereby transforming the original user interface. Also, the transform server 20 systematically exchanges information with a home network middleware to acquire information on a control device on the home network. The transform server 20 includes a transform engine 21, a GUI managing unit 22, a transform rule managing unit 23, a UI DB managing unit 24, the authoring agent managing unit 25 and a renderer agent managing unit 26.

The transform engine 21 receives style information of the display device from the GUI managing unit 22 based on display device information and acquires a transform policy by the display device from the transform rule managing unit 23. Subsequently, the transform engine 21 transforms the original user interface provided from the UI DB managing unit 24 based on the style information and the transform policy of the display device and creates an adaptive user interface.

It is required to perform mapping on a library (LIB) of the original user interface in conformity to the GUI library of the display renderer in order to display the adaptive user interface created by the transform engine 21 on screen and accept input of the user. The GUI managing unit 22 manages a mapping table of the original user interface library, stores and manages the style information of the display device based on the display device information. A default GUI library required which is used when the user interface is formed in the authoring tool is formed on the basis of Java AWT.

The transform rule managing unit 23 manages the transform policy performed in the transform engine 21. The transform rule managing unit 23 includes input transform for managing a user interface policy according to the type of diverse input devices such as a key board, a mouse, a touch pad and a voice, transform by differences of the GUI library, user interface scale transform according to a screen size, resolution, and user preference of a display terminal, and a font/image transform for image zoom or font interchange. The transform rule managing unit 23 manages a transform policy according to a display type of 4 types as an XML document, provides scalability and flexibility by adding only the XML document when a new transform policy is required. When a display terminal of a new style appears, fast update is possible.

The UI DB managing unit 24 receives the original user interface created in the authoring tool, stores and manages the original user interface based on information of a support terminal device and targets user interface information. Also, the UI DB managing unit 24 stores and manages a pre-adaptive user interface to provide a fast service upon request of the user.

The authoring agent managing unit 25 is in charge of actually communicating with the authoring tool. The authoring agent managing unit 25 receives and provides the original user interface and user interface-related information to the UI DB managing unit 24. Only a user interface shape is provided in a preview function provided from the transform server 20 to the authoring tool 10, but an actual control function is not executed. XML information can be efficiently transmitted through communication between the authoring tool and the authoring agent managing unit 25 based on a Simple Object Access Protocol (SOAP).

When the renderer requests a user interface, the renderer agent managing unit 26 creates one renderer agent for each renderer and charges all communications to process the request of the renderer. When one agent creation is requested, the renderer agent managing unit 26 creates an agent performing a corresponding function through information of the display device. The renderer agent receives information of the display terminal, transmits a control device list which can be serviced based on the information, processes selection of the user, actually charges user interface transmission and transmits a control command through the user interface of the user.

The display renderer 30 exists on the display device and is a browser for displaying an actual user interface. When the user executes the renderer, the renderer 30 provides its own display device information to the transform server 20.

The renderer 30 parses the XML script transformed in the transform server 20 and displays the XML script on actual screen. The renderer 30 includes an XML parsing unit 31, an input processing unit 32, a screen forming unit 33, and a Java module creating unit 34.

The input processing unit 32 receives input of the user and transforms the input of the user into the SOAP protocol in order to transmit the input of the user to the transform server 20. The input processing unit 32 charges transform by the input device for diverse devices including a mouse, a key board, a voice and a touch pad.

The screen forming unit 33 actually displays the user interface information transmitted as the XML. That is, the screen forming unit 33 performs actual mapping on the user interface information transformed by the transform engine with the GUI library and efficiently provides the user interface information to the user through a layout manager.

The Java module creating unit 34 actually performs a control command through the transmitted user interface and creates a Java module corresponding to a Java application based on a user interface XML document to reflect a performance result of the user interface. Since the role of the application cannot be performed only by the user interface displayed on screen, a part creating an object and allowing a function to the object is the Java module creating unit 34. That is, the Java module creating unit 34 forms a Java frame object based on the parsed XML document, allows a GUI attribute to the Java frame object and creates a corresponding function.

The authoring tool 10 manages objects used in the user interface and a property of each object and provides an object editor for user interface authoring. The authoring tool 10 also supports mutual transform between the object and user interface markup language (UIML) to store a document. The authoring tool 10 checks whether the UIML document authored by a user interface authoring function based on an XML parser.

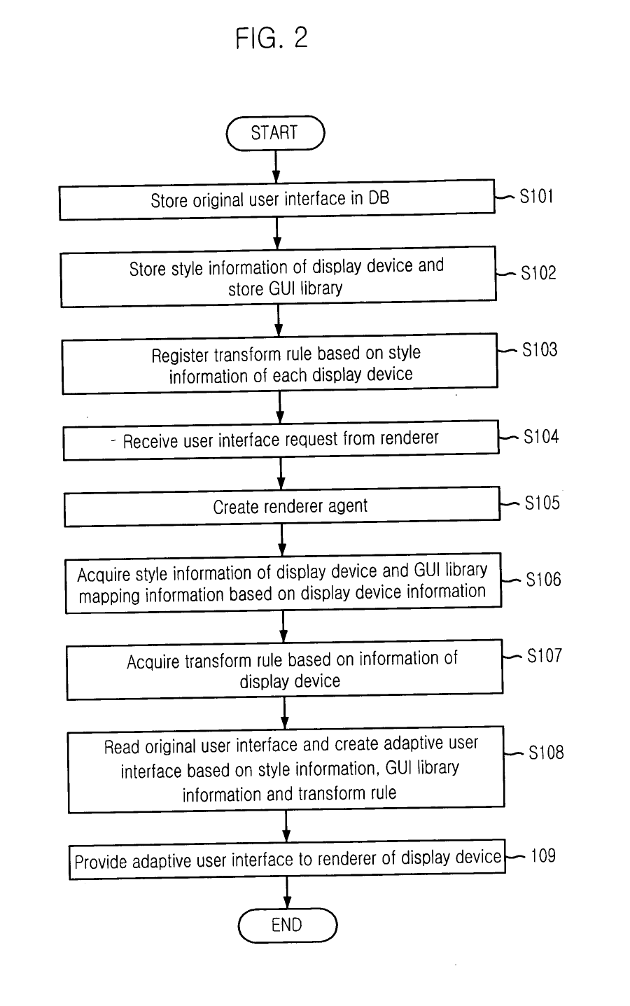

FIG. 2 is a flowchart describing an automatic transforming method of the user interface in accordance with an embodiment of the present invention.

The service developer forms one user interface targeted by the service developer and stores the original user interface in a database of the transform server based on the authoring tool at step S101.

The service developer stores style information of the display device and stores a GUI library in a mapping table at step S102.

The service developer registers a transform rule correspondingly to style information of each display device at step S103.

The renderer set up in the display device sets up resolution of the renderer, an input device, and an output device at an initial setting time. When the renderer is operated, the renderer searches a user interface transform engine capable of receiving a service on a current network. The transform engine transmits acknowledgement to the renderer, and the renderer registers itself in the transform engine capable of receiving the service, receives and checks a user interface list. The renderer requests a corresponding user interface to the transform engine according to the selection of the user.

When the transform engine receives the user interface request from the renderer at step S104, the transform engine creates a renderer agent at step S105 with reference to information of the display device transmitted from the renderer. Subsequent procedures are performed by interaction between the renderer agent and the transform engine.

The transform engine acquires style information of the display device and mapping information of the GUI library from the GUI managing unit based on the display device information at step S106.

Also, the transform engine acquires a transform rule from the transform rule managing unit based on information of the display device at step S107.

The transform engine reads the original user interface in the user interface DB managing unit and creates the adaptive user interface based on the style information of the display device, the mapping information of the GUI library and the transform rule at step S108.

The transform engine provides the created adaptive user interface to the renderer of the display device at step S109.

As described above, the present invention automatically transforms and provides the original user interface properly to the display device, thereby saving a time and human resources required for redesign and automatically updating and maintaining the user interface.

As described above, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent applications No. 2005-0116170 and No. 2006-0072996 filed with the Korean Intellectual Property Office on Dec. 1, 2005 and Aug. 2, 2006, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. A system for automatically transforming a user interface by communicating with a renderer mounted on a display device and communicating with an authoring tool of the user interface, comprising:
a graphic user interface (GUI) managing means for storing and managing style information of the display device corresponding to information of the display device and managing mapping information of a GUI library in a mapping table;
a transform rule managing means for storing and managing a transform rule according to characteristics of the display device;
a user interface database managing means for storing and managing an original user interface authored by the authoring tool;
a renderer agent managing means for creating an agent for communication with the display device;
an authoring agent managing means for creating an agent for communication with the authoring tool; and
a transform means for creating an adaptive user interface by acquiring the style information of the display device and mapping information of the GUI library from the GUI managing means based on the display device information transmitted from the renderer, acquiring the transform rule from the transform rule managing means based on the information of the display device, and transforming the original user interface read from the user interface database managing means based on the style information, the mapping information of the GUI library and the transform rule of the display device.

2. The system as recited in claim 1, wherein the user interface database managing means stores and manages pre-transformed adaptive user interface information.

3. The system as recited in claim 1, wherein a default GUI library stored in the GUI managing means is formed on the basis of Java AWT.

4. The system as recited in claim 1, wherein the transform rule managing means includes a user interface policy based on a type of an input device among diverse input devices, a policy based on a difference between the GUI libraries, a policy based on a user interface scale according to a screen size, resolution and user preference of the display terminal, and a font/image transform policy in charge of image zooming or font change.

5. The system as recited in claim 4, wherein the transform policy of the transform rule managing means is managed as an Extensible Markup Language (XML) document.

6. A method for automatically transforming an original user interface according to a display device, comprising the steps of:
a) registering the original user interface formed by an authoring tool in a database and storing style information of the display device and mapping information of a graphic user interface (GUI) library;
b) registering a transform rule for transforming a user interface correspondingly to the style information of each display device;
c) receiving a user interface request from a renderer of the display device, acquiring the style information of the display device and the mapping information of the GUI library based on the information of the display device, and acquiring a transform rule;
d) transforming the stored original user interface based on the acquired style information of the display device, the mapping information of the GUI library and the transform rule and creating an adaptive user interface; and
e) providing the created adaptive user interface to the renderer of the display device.

7. The method as recited in claim 6, wherein default GUI library mapping information stored in the step a) is formed on the basis of Java AWT.

8. The method as recited in claim 6, wherein the transform rule includes a user interface policy based on a type of diverse input devices, a policy based on a difference between the GUI libraries, a policy based on a user interface scale according to a screen size, resolution and user preference of the display terminal, and a font/image transform policy in charge of image zoom or font interchange.

9. The method as recited in claim 8, wherein the transform policy is managed as an Extensible Markup Language (XML) document.
